(19) United States
(12) Patent Application Publication
(10) Pub. No.: US 2009/0232129 A1
(43) Pub. Date: Sep. 17, 2009

(54) METHOD AND APPARATUS FOR VIDEO SERVICES

(75) Inventors: Albert Wong, Petaluma, CA (US); Jianwei Wang, Novato, CA (US); Marwan Jabri, Tiburon, CA (US); Brody Kenrick, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Dilithium Holdings, Inc., Petaluma, CA (US)

(21) Appl. No.: 12/400,721

(22) Filed: Mar. 9, 2009

Related U.S. Application Data
(60) Provisional application No. 61/068,965, filed on Mar. 10, 2008.

(51) Int. Cl. H04L 12/66

(52) U.S. Cl. 370/352

(57) ABSTRACT

A method for providing a multimedia service to a multimedia terminal includes establishing an audio link between the multimedia terminal and a server over an audio channel, and detecting one or more media capabilities of the multimedia terminal. The method also includes providing an application logic for the multimedia service, establishing a visual link between the multimedia terminal and the server over a video channel, providing an audio stream for the multimedia service over the audio link, and providing a visual stream for the multimedia service over the video link. The method further includes combining the video link and the audio link, and adjusting a transmission time of one or more packets in the visual stream to synchronize the visual stream with the audio stream.

### CROSS-REFERENCES TO RELATED APPLICATIONS

This application claims priority to U.S. Provisional Application No. 61/068,965, filed Mar. 10, 2008, the disclosure of which is incorporated herein by reference in its entirety for all purposes.

### BACKGROUND OF THE INVENTION

This invention concerns the fields of telecommunications and broadcasting, and particularly addresses digital multimedia communications over telecommunications networks.

Present networks such as Third Generation (3G) mobile networks, broadband, cable, DSL, Wi-Fi, and WiMax networks allow their users access to a rich complement of multimedia services including audio, video, and data. Future networks such as Next Generation Networks, 4G and Long Term Evolution (LTE) will continue this trend in media rich communication.

The typical user desires that their media services and applications are seamlessly accessible and integrated between services as well as being accessible to multiple differing clients with varied capabilities and access technologies and protocols in a fashion that is transparent to them. These desires will need to be met in order to successfully deliver some revenue generating services and to ensure branding of services across an operator/provider's various networks. A group of services of significant interest to service providers are called viral applications because their use spreads amongst the population rapidly and with limited marketing drive. Such services build gradually social networks which can become significant in size, and hence in revenue. Hence service providers are interested in introducing such viral applications as quickly as possible and within the capability of the networks already deployed. Different service providers may employ different network technologies or a combination of network technologies to expand access capabilities to the widest range possible of users and user experiences. A challenge is the discovery of viral applications and their adaptation to differing networks capabilities so they can be offered with an attractive user experience to users with varying access capability which may depend on the location of the user (e.g. at home on the web) or mobile (e.g. commuting), or wireless (e.g. in an internet café). Network capabilities can also be augmented. An example of network augmentation is the concept of Video Share, which allows networks to offer video services (in additional to voice) and is presently deployed with unidirectional video services but not interactive or man-machine services.

With the desire of service providers to offer multimedia applications, including viral applications, to widest user base and without hindrance on various access methods (broadband fixed, wireless, mobile) and technologies (DSL, Cable, Edge, 3G, Wi-Fi, WiMax), there is a need in the art for improved methods and systems for receiving and transmitting multimedia information between multimedia telecommunications networks and devices, and in particular over IMS (IP Multimedia Sub-system) channels for media, particularly between Video Share (GSMA IR74) enabled networks, such as 3G/3GPP/3GPP2 networks and wireless IP networks, and other networks such as the internet and terrestrial, satellite, cable or internet based broadcast networks.

### SUMMARY OF THE INVENTION

This invention relates to methods, systems and apparatuses that provide multimedia services to users. Embodiments of the present invention have many potential applications, for example and without limitations Video Share/CSI (Combined Circuit Switched and IMS) augmentation and enhancement, user experience enhancement, Video Share casting, Video Share blogging, video share customer service, interworking between various access technologies and methods, mobile to web services, live web portal (LWP), video callback service, and the like.

According to an embodiment of the present invention, a method of receiving media from a multimedia terminal comprising establishing a voice link between the multimedia terminal and the server over a voice channel, establishing a video link from the multimedia terminal and the server over a video channel, receiving, at the server, a first media stream from the multimedia terminal over the voice channel, receiving, at the server, a second media stream from the multimedia terminal over the video channel, and storing, at the server, the first media stream and second media stream. The method may be further adapted wherein the multimedia terminal is a Video Share terminal. The method may be further adapted wherein the voice channel is a circuit switched (CS) channel. The method may be further adapted wherein the video channel is a packet switched (PS) channel. The method may be further adapted wherein storing comprises storing the first media stream and second media stream at the server into a multimedia file. The method further comprising buffering the first media stream and second media stream at the server and storing on a storage server external to the server. The method may be further adapted wherein the multimedia terminal is a Video Share terminal.

According to an embodiment of the present invention, a method of receiving media from a multimedia terminal for casting to one or more receiving multimedia terminals comprising, establishing a voice link between the multimedia terminal and the server over a voice channel, establishing a video link from the multimedia terminal and the server over a video channel, receiving, at the server, a first media stream from the multimedia terminal over the voice channel, receiving, at the server, a second media stream from the multimedia terminal over the video channel, and transmitting, from the server to the one or more receiving multimedia terminals, a third media stream associated with the first media stream and a fourth media stream associated with the second media stream at the server.

According to an embodiment of the present invention, a method of transmitting media to a multimedia terminal comprises establishing an audio link between the multimedia terminal and the server over an audio channel, establishing a visual link from the multimedia terminal and the server over a video channel, retrieving, at the server, a multimedia content comprising a first media content and a second media content, transmitting, from the server, a first media stream associated with the first media content to the multimedia terminal over the audio channel; and transmitting, at the server, a second media stream associated with the second media content to the multimedia terminal over the video channel. The method may be further adapted wherein the multimedia terminal is a Video Share terminal

According to an embodiment of the present invention, a method of providing a multimedia service to a multimedia terminal comprises establishing an audio link between the multimedia terminal and a server over an audio channel, detecting one or more media capabilities of the multimedia terminal, providing an application logic for the multimedia service, establishing a visual link between the multimedia terminal and the server over a video channel, providing an audio stream for the multimedia service over the audio link, providing a visual stream for the multimedia service over the video link, combining the video link and the audio link, and adjusting a transmission time of one or more packets in the visual stream to synchronize the visual stream with the audio stream. The method may be further adapted wherein establishing an audio link comprises, receiving a voice call from the multimedia terminal via a voice CS to PS gateway, wherein the voice CS to PS gateway, detecting an identification associated with the voice call, and connecting the voice call at the server. The method may be further adapted wherein the multimedia terminal is a Video Share terminal The method may further comprise establishing a 3G-324M media session between the server and a 3G-324M terminal via a 3G-324M gateway, and bridging the audio link and the visual link to the 3G-324M media session. The method may further comprise establishing a IMS media session between the server and an IMS terminal, and bridging the audio link and the visual link to the IMS media session via the server. The method may be further comprising establishing a flash media session between the server and an Adobe flash client, and bridging the audio link and the visual link to the flash media session. The method may be further adapted wherein the multimedia service is an extended video share casting service, wherein the extended video share casting service further comprises streaming video casting from a first group to a first video portal, linking the first video portal to a web-portal page, and streaming the first video portal to a web-browser through a flash proxy component. The method may be further adapted the multimedia service is a video callback service, wherein the video callback service further comprises receiving a busy signal at the server from a second terminal associated with a callee, providing one or more options to the multimedia terminal, wherein the multimedia terminal is associated with a caller, and bridging a call between the callee and the caller according to a selected option.

The method may further comprise establishing a first voice call from a first terminal associated with a first participant to the server, establishing a first one-way video channel from the server to the first terminal, determining the first participant has a priority status, establishing a second one-way video channel from the first terminal to the server, receiving a second video stream from the second one-way video channel, and transmitting the second video stream on a broadcasting channel. The method may further comprises establishing a third voice call from a third terminal of a third participant to a server, establishing a third one-way video channel in direction from the server to the third terminal, instructing video share casting service to the third participant via an interactive voice and video response, broadcasting the first video stream in the broadcasting channel to the third one-way video channel, and joining the third voice call to the voice chatting among the first participant, the second participant and the third participant via the voice mixing unit in the server. The method may be further adapted wherein determining the first participant has a priority sending a video stream from the first terminal to the server further comprises of detecting a second participant requesting casting, and switching the priority sending a video stream to the broadcasting channel from the first participant to the second participant. The method may be further adapted wherein the second terminal of the second participant can be a 3G-324M terminal via a 3G-324M gateway. The method may be further adapted wherein the second terminal of the second participant can be a flash client embedded in web browser via a flash proxy. The method may be further adapted wherein the second terminal of the second participant can be an IMS terminal via an IMS application server.

According to an embodiment of the present invention, a method of providing a multimedia portal service from a server to a renderer, the renderer being capable of receiving one or more downloadable modules, comprises receiving at the server, a request associated with the renderer, providing, from the server to the renderer, a first module comprising computer code for providing a first media window supporting display of streaming video, providing, from the server to the renderer, a second module comprising computer code for providing a second media window supporting display of streaming video, transmitting, from the server to the renderer, a first video session for display in the first media window; and transmitting, from the server to the renderer, a second video session for display in the second media window. The method may be further adapted wherein the request is an HTTP request. The method may be further adapted wherein the first video session is coupled with a first media casting session provided by the server. The method may be further adapted wherein the second media session is coupled with a second media casting session provided by the second server. The method may be further adapted wherein the first video session is captured at the server to a multimedia file. The method adapted wherein the renderer comprises an Adobe Flash player plug-in. The method may further comprise providing, from the server to the renderer, a third module comprising computer code for providing a third media window supporting display of streaming video, transmitting, from the server to the renderer, a third video session for display in the third media window. The method may further comprise transmitting, from the server to the renderer, a first thumbnail image associated with the first window.

According to an embodiment of the present invention, a method of streaming one or more group video castings to one or more video portals, linking the one or more video portals to a web server, and streaming the one or more video portals to a web-browser accessing the web server via a proxy of web-browser plug-in media.

According to an embodiment of the present invention, a method for providing a video share call center service to a terminal comprising connecting a voice session with a terminal, wherein the voice session is established through a circuit-switched network and a media gateway, retrieving one or more video capabilities of the terminal from a user database using a mobile ID of the terminal, providing one or more voice prompts to guide a user to initiate a video session, establishing a video session with the terminal, retrieving a media file and sending a first portion of the media file to the terminal through the voice session and sending a second portion of the media file to the terminal through the video session, providing at least one of one or more voice prompts and one or more dynamic menus to guide a user to access the service, and transferring the voice session and video session to an operator if the user selects operator.

According to an embodiment of the present invention, an apparatus for delivering video value added service to a terminal comprising a media server processing input and output voice and video streams, a signaling server handling incoming or outgoing call, and an application logic unit delivering value added services. The apparatus further comprising a voice processor, a video processor, and a lip-sync control unit.

Many benefits are achieved by way of the present invention over conventional techniques. For example, embodiments of the present invention provide for increased uptake of a Video Share service, a Video Casting application driving greater usage. Embodiments also provide a more complete cross-platform interactive media offering to an operator's subscribers increasing subscriber satisfaction and retention and providing increased average revenue per user (ARPU). Additionally, embodiments provide a video blogging application that allows the sharing of Video Share media to other parties on various other access technologies offering subscriber value added service applications in a convergent manner to multiple devices that a subscriber may owns, allowing a wider variety and accessibility of applications. Additionally, embodiments provide a live web portal application that allows simultaneous sharing of live media casting from different sources into one single location, fulfilling the desire of be capable of seeing as many latest live media contents simultaneously as possible at one place. At the same time, this makes user generated contents to be instantly shared easily.

Depending upon the embodiment, one or more of these benefits, as well as other benefits, may be achieved. The objects, features, and advantages of the present invention, which to the best of our knowledge are novel, are set forth with particularity in the appended claims. The present invention, both as to its organization and manner of operation, together with further objects and advantages, may best be understood by reference to the following description, taken in connection with the accompanying drawings.

### BRIEF DESCRIPTION OF THE DRAWINGS

FIG. 1 is a flow chart illustrating steps for providing a video value added service over combined circuit-switched and packet-switched networks according to an embodiment of the present invention;

FIG. 2 is a system diagram for value added service delivery platform according to an embodiment of the present invention;

FIG. 3 illustrates a system for a video share blogging service according to an embodiment of the present invention;

FIG. 4 is a flow chart illustrating steps for providing video share blogging according to an embodiment of the present invention;

FIG. 5 is a flow chart illustrating a portion of a video share blogging service according to an embodiment of the present invention;

FIG. 6 is a flow chart illustrating a portion of a video share blogging service according to an embodiment of the present invention;

FIG. 7 is a flow chart illustrating a portion of a video share blogging service according to an embodiment of the present invention;

FIG. 8 illustrates a system for a video share casting service according to an embodiment of the present invention;

FIG. 9 is a flow chart illustrating steps for providing video share casting according to an embodiment of the present invention;

FIG. 10 is a flow chart illustrating a video share casting service according to an embodiment of the present invention;

FIG. 11 illustrates a system for an extended video share casting service incorporating a live web portal according to an embodiment of the present invention;

FIG. 12 is a flow chart illustrating steps for providing a live web portal according to an embodiment of the present invention;

FIG. 13 is a system diagram for a live web portal according to an embodiment of the present invention;

FIG. 14 is a flow chart illustrating steps for providing an enhanced video callback service according to an embodiment of the present invention;

FIG. 15 is a flow chart illustrating an enhanced video callback service according to an embodiment of the present invention;

FIG. 16 illustrates a system for flash advertisement according to an embodiment of the present invention;

FIG. 17 is a flow chart illustrating steps for providing a dynamic advertisement according to an embodiment of the present invention;

FIG. 18 is a call flow illustrating a dynamic advertisement services according to an embodiment of the present invention;

FIG. 19 illustrates a system for Video Share customer service according to an embodiment of the present invention; and

FIG. 20 is a flow chart illustrating steps for providing a video share customer service according to an embodiment of the present invention.

### DETAILED DESCRIPTION OF THE INVENTION

A Multimedia/Video Value Added Service Delivery System is described in U.S. patent application Ser. No. 12/029,146, filed Feb. 11, 2008 and entitled “METHOD AND APPARATUS FOR A MULTIMEDIA VALUE ADDED SERVICE DELIVERY SYSTEM”, the disclosures of which is hereby incorporated by reference in its entirety for all purposes. The platform allows for the deployment of novel applications and can be used as a platform to provide value added services to users of multimedia devices, including Video Share enabled devices amongst other uses. The disclosure of the novel methods, services, applications and systems herein are based on the ViVAS (video value added services) platform. However, one skilled in the art will recognize that the methods, services, applications and systems, may be applied on other platforms with additions, removals or modifications as necessary without the use of the inventive faculty.

Real-Time and Live Video Blogging

Video blogging can be made to operate in a real-time and live fashion. For example one can envisage a service where users can navigate to a web site where the video blogs are being transmitted live and in real-time. In other words, as soon as a user/blogger starts a video blogging, the corresponding new entry is made available to the web site in real-time. When a web user clicks on the new entry, the web user sees the live video blogging from the blogger. Users who are transmitting (also called blogging or casting), can do so using mobile handsets equipped with video communication technologies (e.g. 3GPP 3G-324M [TS 26.110]) based handsets, SIP (Session Initiation Protocol), IMS, H.323 or more generally any circuit switched or a packet switched communication technology). Users can also blog from their home using a PC by using a custom application or by navigating to a web page and transmitting a feed from a live camera or from stored files (e.g. video Disk Jockey), other sources, or a mixture.

A web page can show thumbnails of live video casts that a user can navigate to. The user can click on a thumbnail to view that particular blog or cast. The web browser can automatically download a plug-in that can implement the multimedia communication to show the user the blog or the video cast. The plug-in can use an Adobe Flash approach or an ActiveX approach, or more generally a software program or script that can execute within the browser or in the PC and show the user blog or live cast. Simplicity is important here for a minimally intrusive user experience, so the use of a plug-in approach that is widely deployed is desirable. Alternatively the user (e.g. at home on PC or TV) can dial from their PC a service number that connects to the live cast access service. Of particular interest is the Mobile-to-Web configuration where many users can cast to the service from their mobile devices and then users (fixed or with wireless or mobile access) can view these casts. A first challenge in this configuration is the interworking between various modes of access using different technologies, multimedia protocols and codecs. A second challenge is to do with the user experience aspect for how users with various terminal capabilities can access the blogs or casts. The service access and delivery platform need to cater for these different and varied access technologies and methodologies.

Video Share

The Video Share service, described in GSMA IR74 is an IMS enabled service typically provided for mobile networks that allows users engaged in a circuit switched voice call to add one or more unidirectional video streaming sessions over the IMS packet network during the voice call. An example usage in the phase one deployments is a peer-to-peer service where a user sends either live content (real-time capture from a camera) or previously stored content to another user and narrates over the voice channel.

The Video Share requires both a circuit switched connection, which is nearly ubiquitous, and also a packet switched connection, typically UMTS or HSPA, for the video at both the sending and receiving terminal. As present network coverage for the packet connection is generally limited to portions of larger urban centers, the Video Share service is not possible frequently due to lack of coverage at one or both device locations.

Additionally the peer-to-peer Video Share service also suffers from a distinct drawback in that the market penetration of handsets/devices that both support the requisite packet connection and the Video Share application is at a very low level.

The combination of these issues, amongst others including market awareness of the services existence and even its presence on a device, will lead to a very low attempt rate and a very high failure rate for attempted calls.

Video Share Uptake

In order to increase awareness of Video Share, an operator can offer a simple service for a “welcome call” to users either newly activating the service, purchasing a new device which supports the service, or at periods when the users' usage of the service indicates they may be reminded of the service. The service can be invoked on a detection of a SIM registering in a Video Share enabled device and in network coverage (or other triggers). Once this situation is detected, a database may be queried to determine if a reminder or introductory call should be made. A call is made out from the service platform, with an attached Video Share session attempted, to the user. If the user accepts the call and the Video Share session, an instruction portal is accessed that will offer a tutorial, benefits and other service information such as charging or offers. The portal can have an interactive voice recognition portal, and may offer play services such as the previously mentioned Video Share Blogging. This pushed “advertising” of the service will educate the user and help create greater use of the Video Share services. This service might also be provided to users roaming into a new area even if in the same network and country to provide information about the local area (e.g. a “welcome wagon” call). This may be performed in a free call manner or sponsored by local businesses receiving advertisement and offering services.

A way to increase the call attempt and success rate for Video Share services is to remove the necessity for two enabled parties to be involved in a service. Video Share Blogging is a service that requires only a single Video Share user.

Video Share services that involve multiple parties are also a compelling way to increase viewing minutes and service uptake especially amongst circles of friends. Video Share Casting is such a service.

More compelling peer-to-peer services can also be created where a platform internal to the network is employed to offer services such as media processing, dynamic avatars prompted from the voice stream (this can create a bi-directional video call by using two outward video legs from the service platform, a feature that is otherwise not available in video share), or themed sessions.

In particular, Video Share services that do not require the addition of clients or on device portals, or extensions beyond the support of standard Video Share will be services that more easily reach a larger audience and have a reduced barrier on uptake. It is also possible that clients extending functionality can be created and provided for various devices via the application stores for those devices.

Video Value Added Services Implementation to CSI Systems

A preferred embodiment of the invention is discussed in detail below. The present invention can find its use in a variety of information and communication systems, including circuit-switched networks, packet-switched networks, fixed-line next generation networks, and IP subsystem multimedia systems. A preferred application is in a combined circuit-switched and packet-switched network system for a value added service.

In the following discussion, the value added services are referred to as the video share services platform. Further, the video share services platform has a connection to circuit-switched networks via media gateways, connection to flash clients via flash proxies and connection to IMS systems via IMS gateways. A user terminal to be provided the service is referred to as a user end-equipment receiving the value added services via combined circuit switched and packet-switched networks. The user terminal in the combined circuit switched and packet-switched networks is called CSI terminal, or called video share terminal.

A user terminal in a circuit-switched network, or in an IMS network, or provided by flash in a web browser (or desktop platform for web services such as Adobe AIR or various widgets/sidebar platforms), is also able to receive the value added services via media gateways or flash proxy.

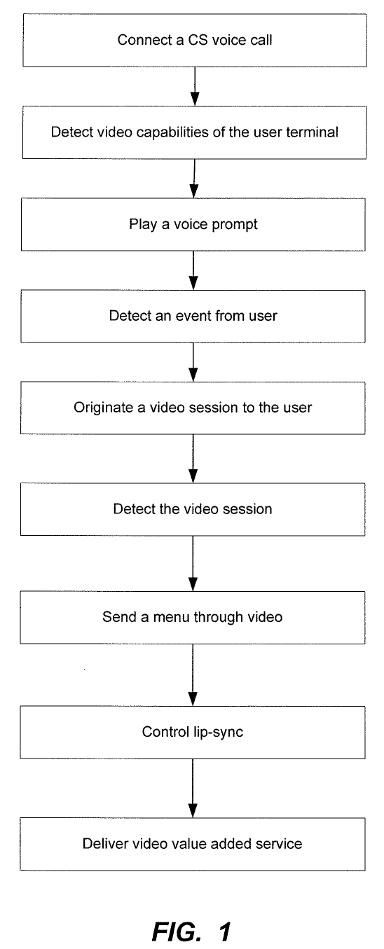

FIG. 1 is a flowchart depicting the method of video value added service in CSI systems according to a preferred embodiment. The delivery of value added services to a user terminal in CSI networks involves establishing a voice link between the user terminal and a server over a voice channel; detecting media capabilities of the user terminal through user identity information and service information; establishing a video link between the user terminal and the server over a video channel; combining or associating the video link to the voice link; adjusting a time of sending or receiving video packets, such as by means of delaying appropriately the voice packet delivery time, to synchronize with the voice channel; and delivering an application service by playing audio stream over the voice channel and video stream over the video channel.

As the CSI networks deliver voice channels through circuit-switched networks and deliver video channels through packet-switched networks, the first step for a server providing video share services to the user terminal is that the server should establish a voice call from the user terminal. Establishing this voice call comprises receiving a voice call from the user terminal via a voice-over-IP gateway, wherein the voice gateway transferring a voice call signaling in a form of circuit switch into a voice call signaling in a form of packet switch; detecting a caller ID of the voice call; negotiating voice capabilities between the voice-over-IP gateway and the user terminal and determining a voice codec type in connection; and answering the voice call.

In many situations, a user terminal that called into the value-added service may not have sufficient capabilities to get a particular value added service. For example, the place that user terminal is calling from is just covered by a 2G or voice-only networks and the user terminal cannot send or receive video. For another example, the user terminal may not subscribe the value added services. Thus, the server needs to detect media capabilities of the user terminal. The detecting comprises steps of obtaining a caller ID associated with the user terminal from a voice call signaling message; detecting privileges of the user terminal by inquiring information associated with the caller ID in a first database; detecting video availabilities provided by the networks where the user terminal is calling by inquiring information associated with the caller ID in a second database; and determining the user terminal meets requirements of the service.

If the user terminal is detected as not having capabilities to receive value-added services, the server will send some voice messages to the user terminal. This voice message can be sent using a protocol via a call signaling channel.

If the user terminal is found to have video capabilities to get value-added services, the server starts to establish a video link through packet networks. Establishing a video link comprises steps of originating a video call to the user terminal via IMS networks; sending voice prompts to the user terminal for helping setup the video call; receiving an answer message from the user terminal via IMS networks for the video call; negotiating video capabilities with the user terminal to determine a video codec type for the video call; sending an acknowledgment signal to the user terminal; and sending a video stream to the user terminal in a format of the video codec type for the video call.

Thus, it has established a voice link and video link between the server and the user terminal. The voice link is through circuit-switched network and it is two-way. The video link is through packet-switched networks. The video link can be one-way or two way. In the video share framework, the video-link is one-way.

As the voice link and video link are connected through two different paths, one is circuit-switched, and the other is packet-switched, the server can identify incoming media streams from different ports or paths, and combine the voice link and video link in a single media session associated to the user terminal. The combining process involves steps of registering a call ID which is for establishing the voice link to a database; registering a second call ID which is for establishing the video link to the database; and linking the two call IDs as a single media session to the user terminal.

When the server sends a media stream to the user, the server sends an audio part of an outgoing media stream to the path associated to the voice link call ID, and a video part of the outgoing media stream to the video link call ID. When the server receives and records an incoming media from the user terminal, it can combine the audio session from the voice-link call ID and the video session from the video-link into a single media file (e.g. a container format like 0.3GP or similar).

As the voice and video sessions between the user terminal and the server are received via two different networks, the arriving time of the audio stream, and the arriving time of the video stream can be different. It can have some offset or jitter which will create lip-sync issues.

In order to eliminate the lip-sync issues due to different paths, if the media stream is sent from the server to the user terminal, the server can adjust the time of sending video either ahead of audio or behind audio in order to get the audio and video streaming arriving to the user terminal at the same time. Additionally or alternatively, the server can use skew indications to provide information on the lead/lag of audio with respect to video (e.g. RTCP is one possible mechanism).

If the media stream is sent from the user terminal to the server, the server can adjust time of receiving video when it combines audio and video sessions together.

One way of adjusting the of sending or receiving video packets in the server consists of estimating the end-to-end delay of the voice link, estimating the end-to-end delay of the video link, and controlling sending time of video packets before or after sending voice depending on the difference between the time of end-to-end delay of the voice link and the time of end-to-end delay of the video link.

The adjustment of sending or receiving audio and video packets in the server can be achieved in a number of ways depending on the systems implementation or protocols used.

For example, one approach for adjusting a time of sending or receiving video packets can be implemented through a protocol between the user terminal and the server. The user terminal detects an arriving time of first voice frame in the voice link, and arriving time of first video packets in the video link where the first voice frame and the first video frame are sent at same time at the server according to the protocol. The user terminal can send a feedback message to the server. The feedback message can contain information of network delay or the difference between voice link path and video link path. The feedback message can be sent through signaling layer. Based on the feedback message, the server can adjust sending time of voice frames and video packets to control the voice frames and the video packets arriving to the user terminal at same time. The user terminal also can adjust decoding time depending on the difference between the arriving time of voice frames and video packets to play the voice and the video at the terminal at same time. Either adjusting time on the sender side or on the receiver side depends on the protocol between the user terminal and the server. This should also apply to the direction of media stream from the user terminal to the server.

For another example, the approach to adjust lip-sync between voice and video can be implemented through an interactive response method. The user terminal can send message such as DTMF (Dual Tone Multiple Frequency) signals (or alternatively DTMF digits or User Input Indications) to the server to control the lip-sync problem dynamically via interactive voice and video response and DTMF messaging. The DTMF can be in-band or out-of-band. The server can detect DTMF to adjust the time to send voice frames and video packets accordingly.

The delivery of the value added service from the server further comprises a few basic steps executing application logic defined by the application service; loading a media from a content provider system; sending audio part of the media to the user terminal over the voice link; sending video part of the media to the user terminal over the video link; receiving incoming voice from the voice link; receiving incoming video from the video link; saving the incoming voice and the incoming video in a media file accordingly; and transferring the media file to a file system.

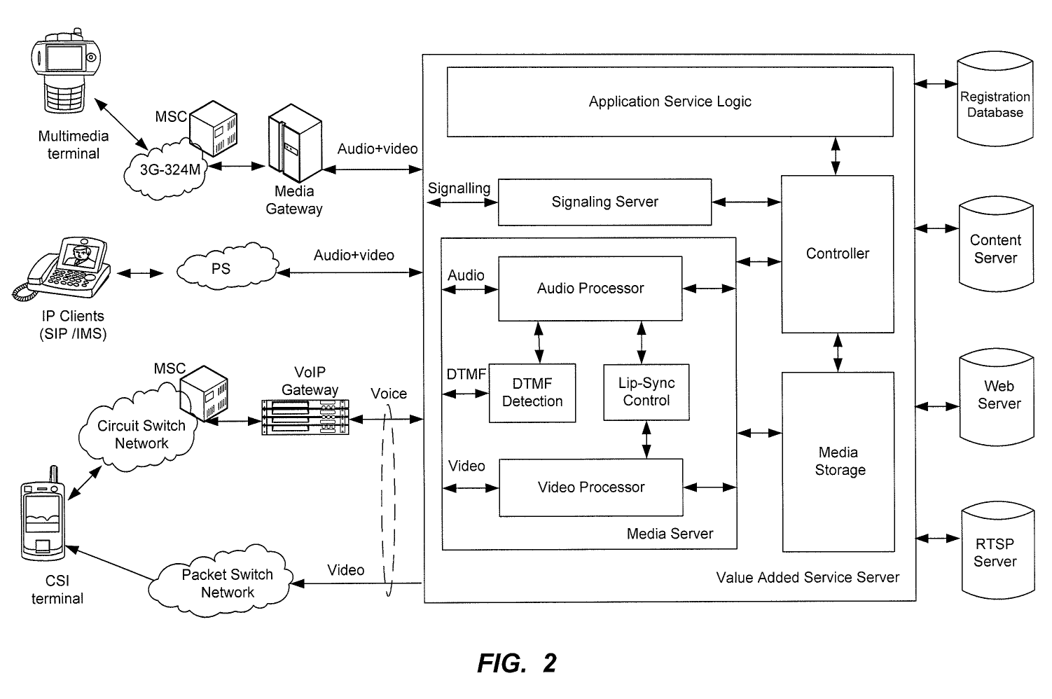

FIG. 2 depicts a block diagram of a system of a value added service platform according to an embodiment of the present invention. The system contains an application service logic module, a signaling server, a media server, file storage and a controller. The media server includes an audio processor, a video processor, a DTMF detection module, and a lip-sync control module. The signaling server handles input or outgoing calls in signaling layer. The media server processes input or output media streams including audio and video. The media server also processes DTMF detection either in-band or out-of-band. The lip-sync control module is to synchronize the time of sending or receiving voice and video packets due to the voice and video come from different network paths. The file storage stores or retrieves media files or data files. The controller interprets application service logic, controls each module, and delivers application service instructions.

The value added service platform further incorporates additional external units to deliver the value added service to a user. The external units might include a media gateway, a registration database, a content server, an RTSP streaming server, and a web server. Some external units can be optional depending on the provided application services. The media gateway functions as a bridge to link to circuit-switched networks. The media gateway can be a voice over IP gateway or a voice circuit-switched to packet-switched gateway if the gateway only supports voice codecs.

The value added service is through a voice channel, established on a circuit switched network, and a video channel, established on a packet switched network.

The value-added service platform can be an interactive video and voice response service platform.

The user terminal that receives value added service needs not be limited to a CSI terminal. It can also be a 3G-324M terminal. The user terminal operating in CSI mode can interwork with a 3G-324M terminal through the server with involvement of a 3G-324M media gateway, and the process comprises establishing a media session between the user terminal and the server wherein the media session has voice data via a circuit-switched network and video data via a packet-switched network; establishing a separate 3G-324M media session between the server and a 3G-324M user terminal via a 3G-324M gateway; bridging the media session and the 3G-324M media session via the server; and connecting the user terminal to the 3G-32M user terminal.

The user terminal can also be an IMS terminal, or an MTSI terminal. The server can provide an IMS media gateway to provide value-added service to such terminals. This involves steps of establishing a media session between the user terminal and a server wherein the media session has voice data via a circuit-switched network and video data via a packet-switched network; establishing a second media session between the server and an IMS user terminal; bridging the media session and the second media session via the server; and connecting the user terminal to the IMS user terminal.

Further, the user terminal can also be a web browser with an internet/network connection. Any web browser with flash support that has downloaded a flash client can join the value-added service via a flash proxy in the server. A flash proxy allows adapting a media session from one protocol to a flash compatible protocol that can be processed by a flash client and vice versa. The flash client exists as a plug-in to a web browser. This process involves steps of establishing a media session between the user terminal and a server wherein the media session has voice data via a circuit-switched network and video data via a packet-switched network; establishing a second media session between the server and an Adobe flash client via a flash proxy component; bridging the media session and the second media session via the server; and connecting the user terminal to the Adobe flash client user terminal.

The server plays a media streaming to the user or records a media streaming from the user where the media can be in a media file which contains time synchronization formation. The media file can be a 3GP format.

Video Share Blogging

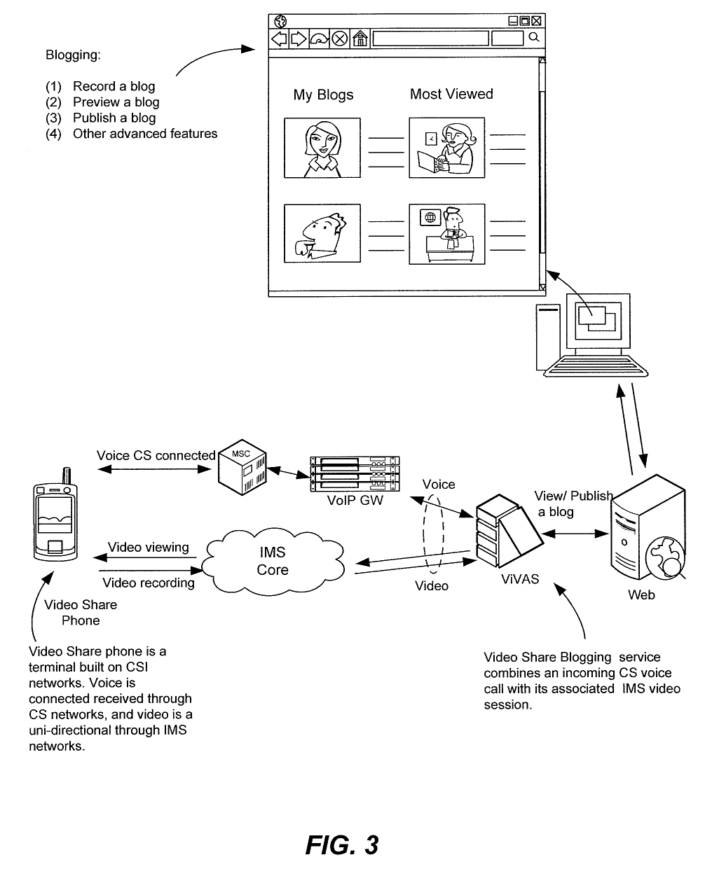

Video Share Blogging is an application that can be deployed with the Video Share service via a server based value added services platform. It provides an extra video value added service to the existing Video Share service providers, and it increases the probability of successful use of the Video Share service as it does not require two parties to be in Video Share enabled situations. FIG. 3 illustrates an architecture of video share blogging according to an embodiment of the present invention. A user terminal “video share phone” accesses the video share blogging service provided by a server “ViVAS”. The voice and video paths between the “video share phone” and the “ViVAS” are via different networks. The voice path is through a mobile switch center “MSC” and a voice over IP gateway “VoIP GW”. The ViVAS platform might also have a time division multiplexing (TDM) connection enabling direct connection to the MSC over ISUP/ISDN/SS7. The video path is through an IMS core network. The voice is bi-directional. But the video is half-duplex (one direction at one time). When the “video share phone” sends video to the “ViVAS” for recording, the video direction has to be switched from “video viewing” to “video recording”. A web server is connected with the “ViVAS” to provide blog pages to web browser clients.

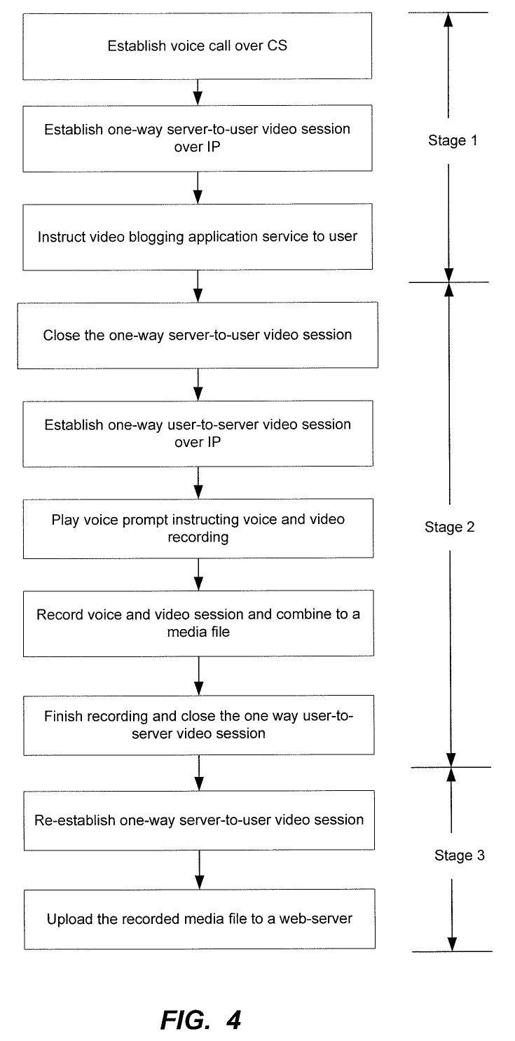

FIG. 4 is a flow chart depicting a method of video share blogging service according to a preferred embodiment. The video share blogging service comprises three stages: (1) establishing voice and video media path connection and playing voice and video message to guide users on use of the service; (2) combining and recording incoming voice and video to a media file; and (3) uploading or publishing the recorded media file.

As the voice path is a two-way circuit-switched voice call via a voice gateway, and the video path is an one-way video streaming session via a packet-switched network, it is required to switch the direction of one-way server-to-user video streaming to the direction of one-way user-to-server for video recording. This switching step needs to close the previous video session and to re-establish a new video session in recording stage. This process can be triggered through interactive voice response processes with DTMF detections at the server. After finishing recording, the recorded media file needs to be pre-reviewed or be uploaded to a web server. Again, the video session needs to be re-established to get video streaming from the server to the user.

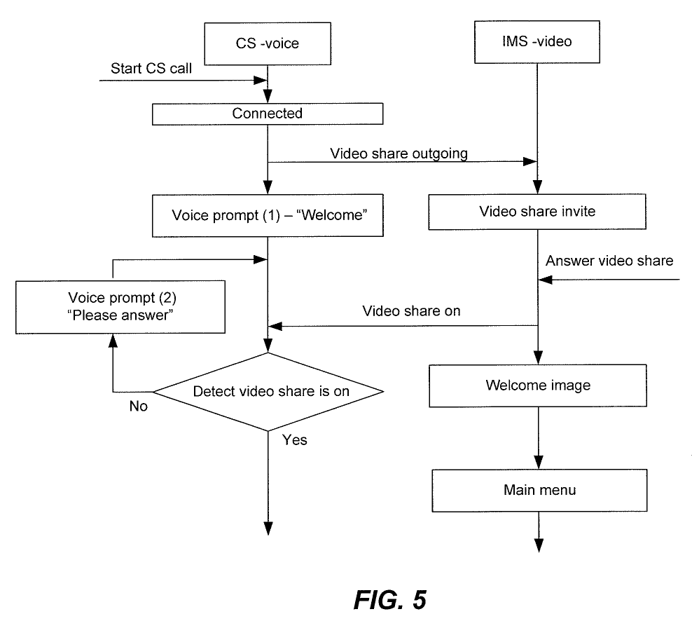

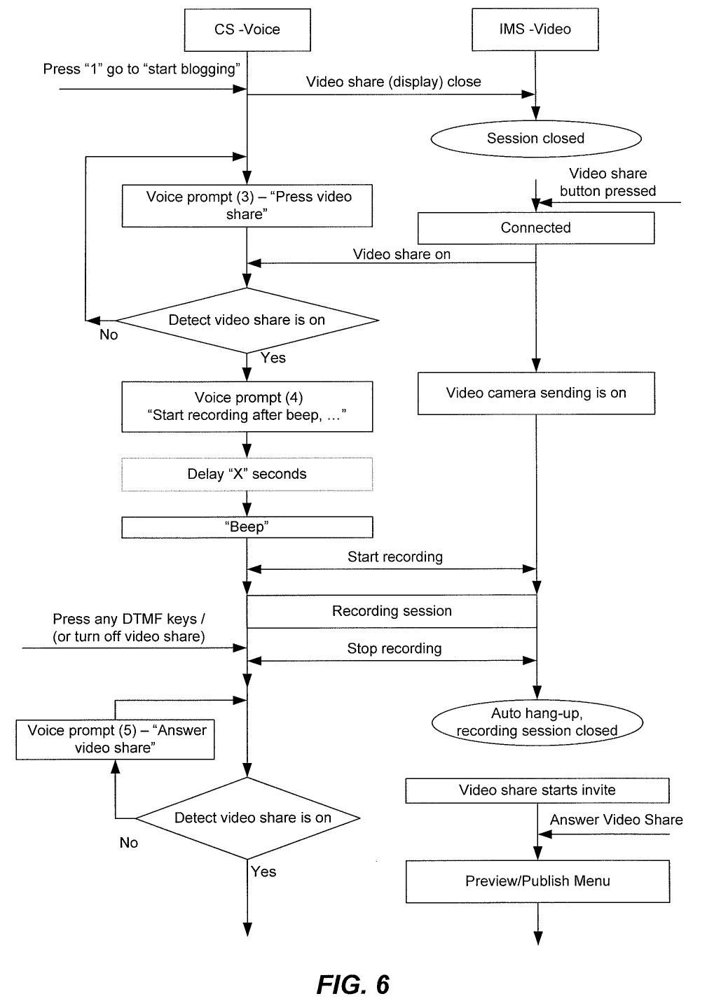

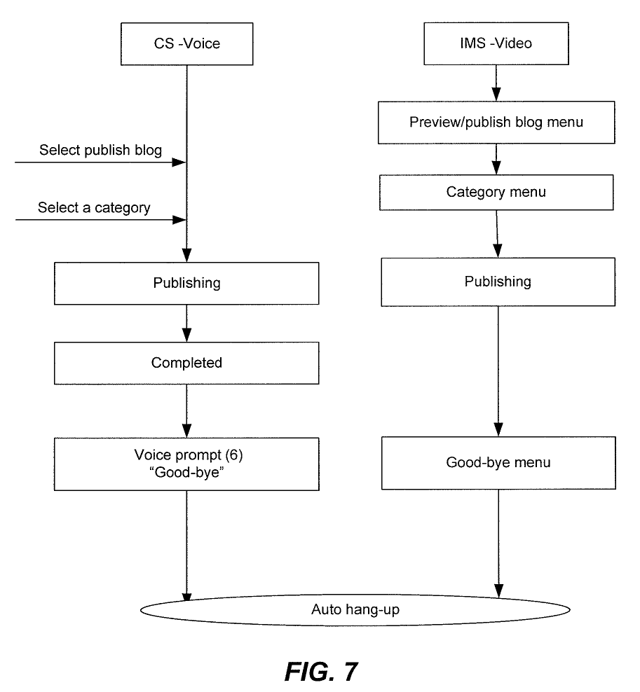

Video Share Blogging is a man-to-machine (or server) application. A user with a Video Share handset makes a circuit switched voice call to a server. The server runs the Video Share blogging application acting as a termination for the Video Share session without needing a second party. A call flow according to an embodiment of the present invention is shown in FIG. 5, FIG. 6 and FIG. 7.

As illustrated in FIG. 5, when the server receives the call, it detects whether the user has a Video Share enabled handset and the service being available (i.e. network coverage and device registration) by querying a database of registrations, this may be done through a Home Subscriber Server in the IMS core network. When it discovers the user terminal is a Video Share enabled device, it launches a unidirectional video session from the server to the user, which when accepted by the user, will display video on the user terminal. The video can be an instruction menu or instruction video clips, or any video stream. The server may also provide complementing audio.

The user can continue to interact with the Video Share blogging service at the server, outputs to the user are through the video and the voice channel and the user interacts either via voice or by pressing DTMF keys. As in FIG. 6, the video blogging service allows users to record one's own media, upload media, review video blogs or clips, rate video blogs, etc. The audio or voice session is through a circuit switched network and the video is through a packet switched network. The audio session may be routed through a packet switched network and with a voice gateway before reaching a circuit switched network. The packet switched network may be laid out over IMS. The service combines circuit-switched voice and packet switched video.

As illustrated in FIG. 6, when the user selects the recording mode or uploading mode, the server changes the video session from sending to receiving (as the video is unidirectional) by terminating the current session and providing instructions to the user to start a new session. As the Video Share service requires the user to press a video share button in the handset or other menu options to enable video in order to push live video to the server, the instructions will playback an instruction indicating to do so. In some handsets, it is possible to allow users to send pre-recorded video clips stored in the handsets. The server records audio and video from the two separate paths. Audio is through a circuit switched network and video is through a packet switched network. The server manages lip-sync of recorded audio and video by monitoring audio and video sessions. The server can combine recorded audio and video into one media file immediately or can store the audio and video in different storages with associated labels and synchronization information.

The user can stop the recording by pressing any DTMF key, terminating the Video Share or a particular key to indicate stopping recording. It is also possible to have the session terminated via a voice command or voice detection and embodiments are enabled to determine when this is the case and remove the end portion of the video associated with the issued oral command so as to not have the signing off speech in the blog. This can be done by determining the onset of speech that caused the automatic speech recognition (ASR) to detect the command. After the user finishes the recording, the server switches the direction of the video session to start the video from the server to the user; this is done via a newly initiated Video Share video session. After answering or accepting the session, the user can preview the recorded media. Again, the audio session is played through a circuit-switched network.

Once the user is satisfied with the recorded video, he can press a DTMF key to publish his recorded media clips as a blog on a web as shown in FIG. 7. The server combines recorded audio/video sessions into one media file and transfers the media file to a blog or a video site such as You Tube. The user can also tag the content, or select different categories or a different web/storage location depending on a personal desire or profile.

Once the blog is published, it can be viewed by others who may be asked to register a service to access the blog page.

There is an alternative approach in Video Share blog. An interworking function (IWF) may combine with a Video Share server in a Video Share blogging application. The circuit-switched voice session is combined with video through an IWF. The audio and video sessions are combined, into for example a SIP audio and video session, before reaching the blogging server.

Video Share Casting

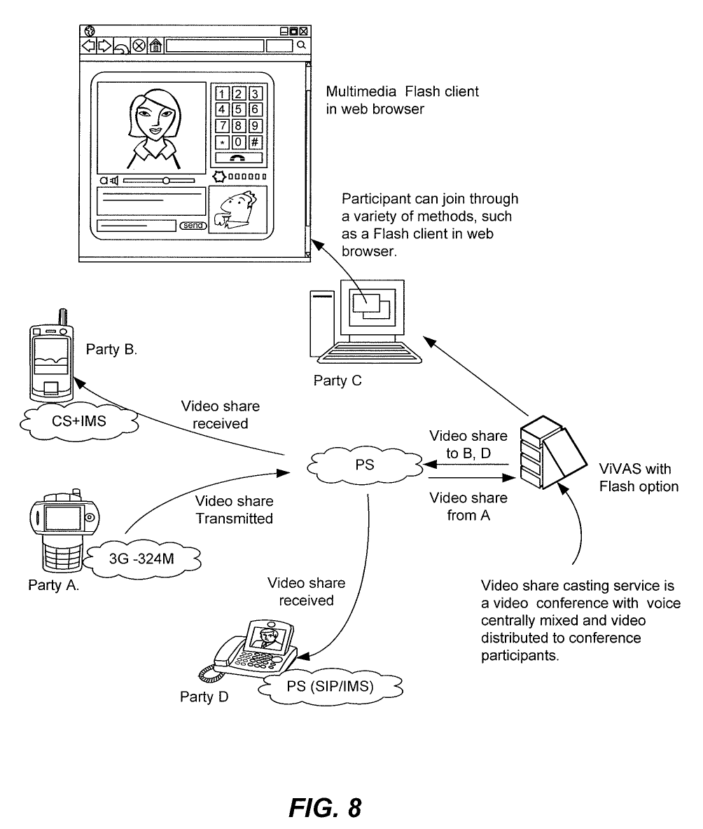

Video share casting is an application based on the video share service which is an IMS enabled service for mobile networks that allows users engaged in a circuit switched voice call to add a unidirectional video streaming session over the packet network during the voice call which is then distributed to one or more additional parties that access the service, perhaps via a particular call-in number. It is as illustrated in FIG. 8 where the parties are video share enabled devices, 3G-324M video phones and other SIP devices or PC/Web based videophones, such as that enabled via a flash proxy. The underlying framework of the video share casting can also be known as mobile centrix, or short-formed motrix. It provides an extra video value added service to complement the existing video share services offered by a provider.

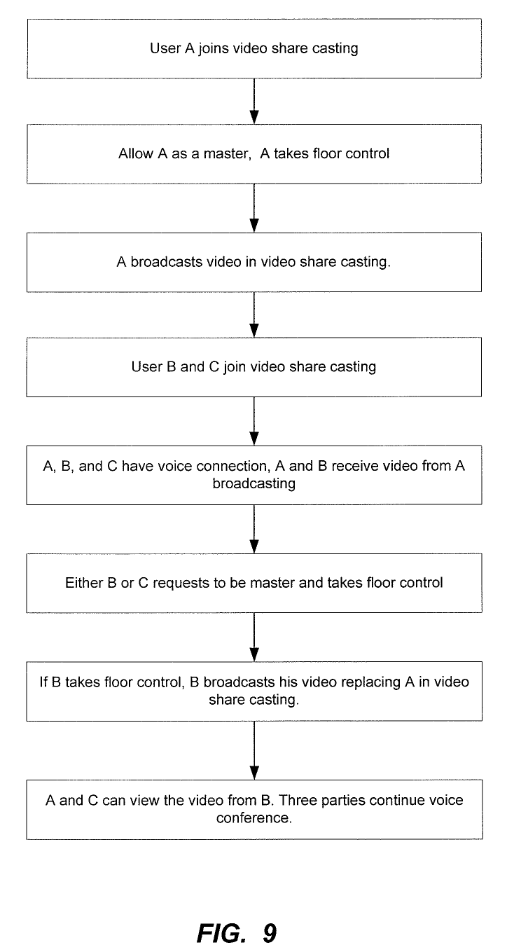

FIG. 9 is a flow chart depicting the method of video share casting according to a preferred embodiment. Video share casting provides multiple users the ability to join in a multi party video push to view like service or video chatting. Access to a particular Video Share casting channel can be via a pre-determined access number or providing a prompt for entering a channel number on entering the service. A user can then start launching a video casting. If he is the first person or he is registered as a master in the casting, he is able to broadcast his video. When other users join the call, they can view the broadcast video while they can interactively join in the voice call. Their voice sessions are mixed through an MCU at the server. It is possible that other users can take actions to take control of the video casting stream such as by means of DTMF key input.

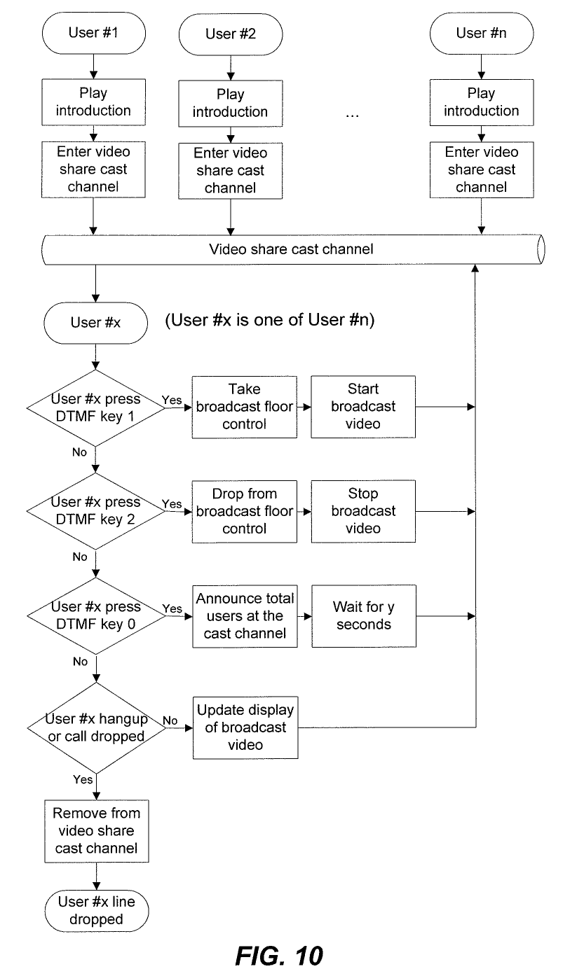

FIG. 10 illustrates a flow chart of video share casting service in more detail. Video share casting provides multiple users the ability to join in a multi-party video push to view like service or video chatting. It is possible that any users can take actions to take control of the video casting stream. For example, they can press DTMF keys to switch video casting stream or begin transmitting their own video share (after terminating their video share receive). A user can stop broadcasting its video by pressing a DTMF key, or terminating their Video Share session. If there is another user actively queuing to broadcast its video, the video of that user will be broadcast subsequently. If there is no user actively queuing to broadcast its video, no video may be broadcasted and a filler image or video may be displayed entreating a user to begin sharing.

During video share casting, the video share casting can provide additional features. For example, users can press some DTMF keys to switch from viewing the video casting to a display showing conferencing call information, which might also have a menu indicating options.

The video share casting can also integrate “anonymising” avatars, either being one or more pictures, or a moving animated figure synchronized with (generated from) the voice of a user.

The video share casting service may offer more than one casting mode. Apart from broadcasting the video from a user who is the latest person to initiate the broadcasting, the broadcasting of video can be selected to be always from the last user or the last user online joining in the video share casting. Another casting mode is the moderator selected mode, which the broadcasting of video is to be selected by a master user or a moderator of the casting. A further casting mode is the loudest speaker mode, which is to follow the loudest speaking user to broadcast his video. For both of the moderator selected mode and the loudest speaker mode, there can be further variations of the embodiment such that the selected user should be the user having agreed to start broadcasting his video by pressing the video share button on his terminal. Otherwise, there will be no change of the broadcasting source, or the broadcasting of the video will be a replacement video with or without linkage with the selected user, or the broadcasting of the video will be an avatar, either static or animated following the voice of a selected user.

The video share casting can be further extended to a multi-casting service from single casting service in a conferencing call or chat. For example, multiple users can broadcast their video, and other users can select the cast to view. On selection of another user who is not currently broadcasting his video, an avatar may be automatically played.

There is an alternative application in video share casting. The broadcasting video can be a media clip in some applications. For example, the master user can switch from broadcasting his video to a media clip from a portal through DTMF key controls.

A user can press a DTMF key or generate a signal to enable a menu in Video Share casting to activate supplementary features such as announcement of total number of current users, displaying a list of current users' names and/or locations, selection of avatar, request to enter a private chat room with another one or more users, broadcasting a text message to be overlaid on the broadcast video, etc.

Users who join video share casting are not restricted to video share users only. Users who have 2G or 3G terminals also can join the video share casting. For example, the 2G or 3G terminals can access video share casting service through a voice over IP gateway or a 3G media gateway to the server. Users who have only web browser also can join the casting through flash proxy servers. Most PC web browsers have the adobe flash plug-in installed. The user can access a flash proxy server with a flash client and the server will translate/transcode the session and media sent and received with the flash client to another protocol such as SIP. The flash client can call a service number for video share casting through a flash proxy server, and thus join the video share casting as a SIP terminal. The flash proxy server may also be co-located with the flash client.

Users may have different terminals. The video share casting server can combine media transcoder servers or transcoding functions in the server itself to provide media transcoding to different participants.

Live Web Portal—Extended Video Share Casting

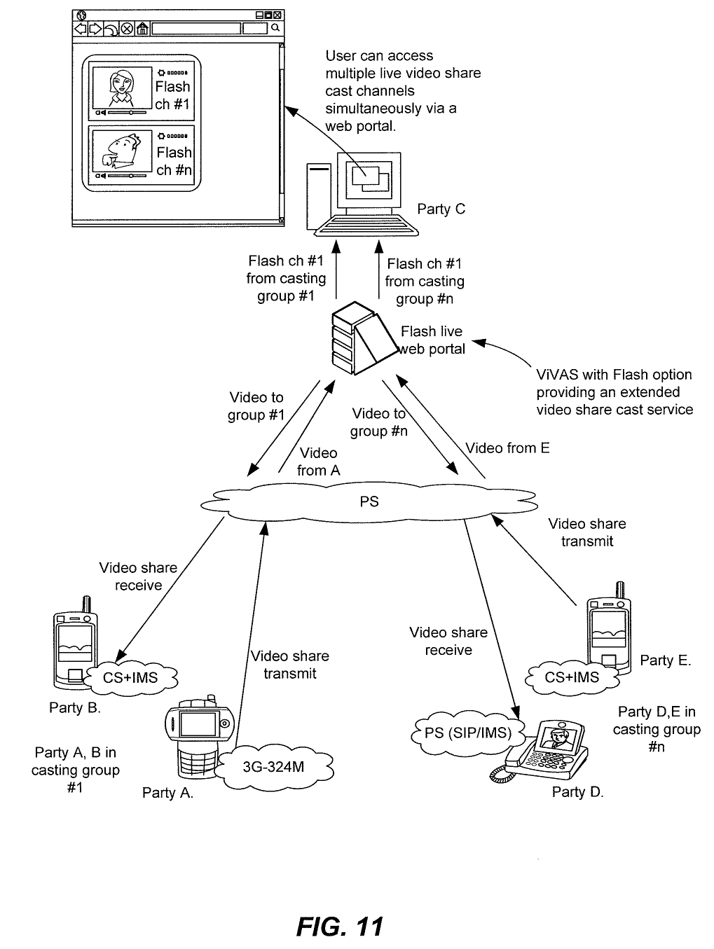

An embodiment of the present invention provides an extended mobile centrix service or an extended video share casting service on ViVAS, as illustrated in FIG. 11. There are one or more simultaneous mobile centrix service accesses/channels with different access numbers via mobile devices at the same time. A user intending to start or stop video casting from cameras or stored media files presses a DTMF key or a pre-assigned key to take the floor control or be removed from the floor control. A user can access a web browser to connect to a URL to view the one or more simultaneous mobile centrix sessions in real-time or in offline playback mode. Audio from each caller into the mobile centrix are mixed together per service access number. The mixed audio is played back to the web browser as well. Meanwhile, video from the caller taking the floor is distributed to all other callers using the same service access number, including web browser access. The service is also accessible by users using fixed line devices or devices without video support or without video share support.

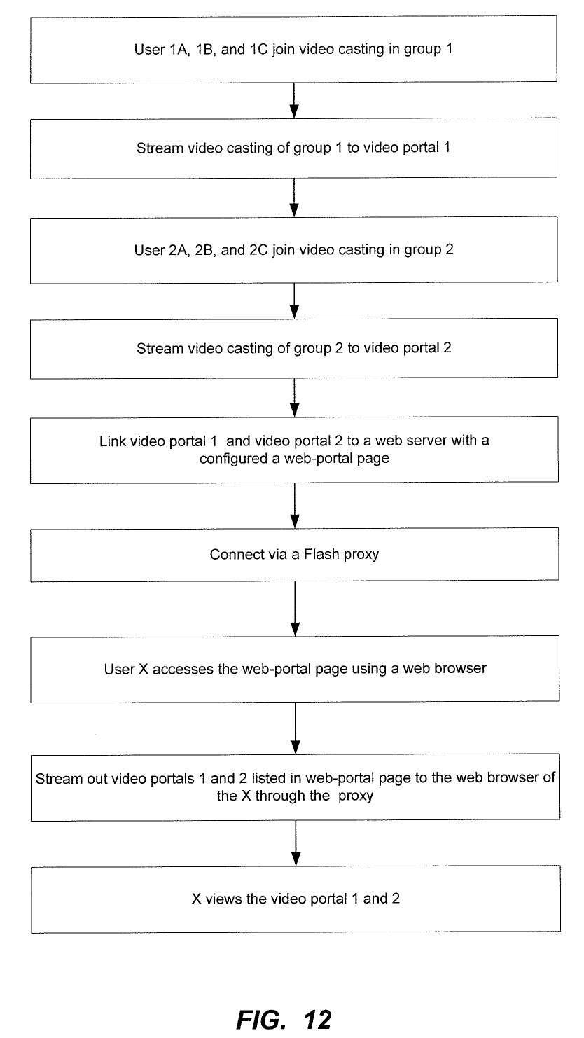

FIG. 12 is a flow chart depicting the method of extended video casting service on the ViVAS to a live web portal according to a preferred embodiment. A group of users (1A, 1B, 1C) all join video casting in group 1. Another group of users (2A, 2B, 2C) all join video casting in group 2. The live web portal service stream the video casting in group 1 to video portal 1, and the video casting in group 2 to video portal 2. The live web portal service can link the video portal 1 and video portal 2 to a web server, and can configure a web page as a web portal containing video portals 1 and 2 as web portal channel 1 and channel 2. The live web portal connects a proxy which converts media streaming to a media format of web browser plug-in module. When a user (X) accesses the web server and surfs the web portal page by a web browser, the live web portal service streams the video portals 1 and 2 out to the user via the proxy. The user can view the video portals 1 and 2 simultaneously in his web browser. The user can also select one of the video portals and join one of video casting group via the live web portal service with the proxy.

A detailed working mechanism of an embodiment has the service operated in two parts including the packet-based call operation and the web access operation associated with the packet-based call operation. The server of the video cast service receives a call from a caller and plays a prompt to the caller. The caller makes the call from either a SIP terminal, a 3G-324M terminal or a video share terminal.

For the channel establishment, an audio channel is started first in both directions, followed by a video channel from the server to the caller. For the video channel request received by the caller, the caller may need to press an accept button before video can start to be played to the caller. One or more prompts including a welcome prompt and an instruction prompt may be played back to the caller. The caller starts video casting by pressing a DTMF key to indicate the beginning of the video sending from the caller to the service. The terminal of the caller may show the currently casting status indication locally, in particular for a video share terminal, or the indication is provided by the server. The caller stops video casting by pressing a DTMF key, terminating a video share session, or hanging up the call to indicate the end of the video sending. The instruction prompt may be played back to the caller again if the session is still maintained.

When more than one callers call into the same service number of the same video casting channel, the second caller joining in the call may start video casting by pressing a DTMF key to indicate the beginning of the video sending. This will override the existing video casting by another caller. When the second caller finishes casting by pressing a DTMF key, the video casting will be immediately and automatically continuing from the first caller as it becomes the active casting source.

The associated channel for video display over a flash object for the web access operation may be started manually or automatically by a mouse click when the live web portal is loaded on a web browser. The flash object may be shown as a thumbnail image associated with the channel before it is started. The thumbnail image may be a standalone image, e.g. in JPG or PNG format, and may not come from the flash object. The thumbnail image may be updated periodically at the web browser. The update of the thumbnail image may be retrieved from the server via HTTP where the server refreshes the thumbnail image from time to time associated with the channel when it is active. The thumbnail image refresh with the latest video snapshot may be extracted by means of recording a new media stream from the channel for a short period of time and then getting the first picture of the recorded stream as the updated thumbnail image. Either being started manually or automatically, the flash object starts a SIP session via a flash proxy using RTMP protocol to the server. The casting channel content, if available, is immediately shown to the flash object in real-time.

The video casting channels number for the packet-based call operation ends with an even number digit. The associated channel for video display over a flash object for the web access operation has the channel number immediately next number for the video casting channel.

All channels including the one or more channels from the packet-based call operation and the channel from the web access operation are connected to an MCU such that all channels are virtually in the same conference room and at the same conference. The video channels are centralized at the server and cast and distributed according to the configuration.

There are further variations of the embodiment on the web access operation such that each flash object associated with the corresponding packet-based call operation can serve different purposes. One purpose is to automatically play back the latest captured video clip of the channel when the channel is idle such that no one is casting content. The channel numbers may have some preselected ending-digit numbers. Another purpose is to randomly show a snapshot of a previously captured video clip from the one or more channels of the service. The video clip is played when the user clicks on the snapshot, which starts a flash call to the corresponding service number of ViVAS. The channel numbers have the ending-digit numbers different from those channels for the packet-based call operation.

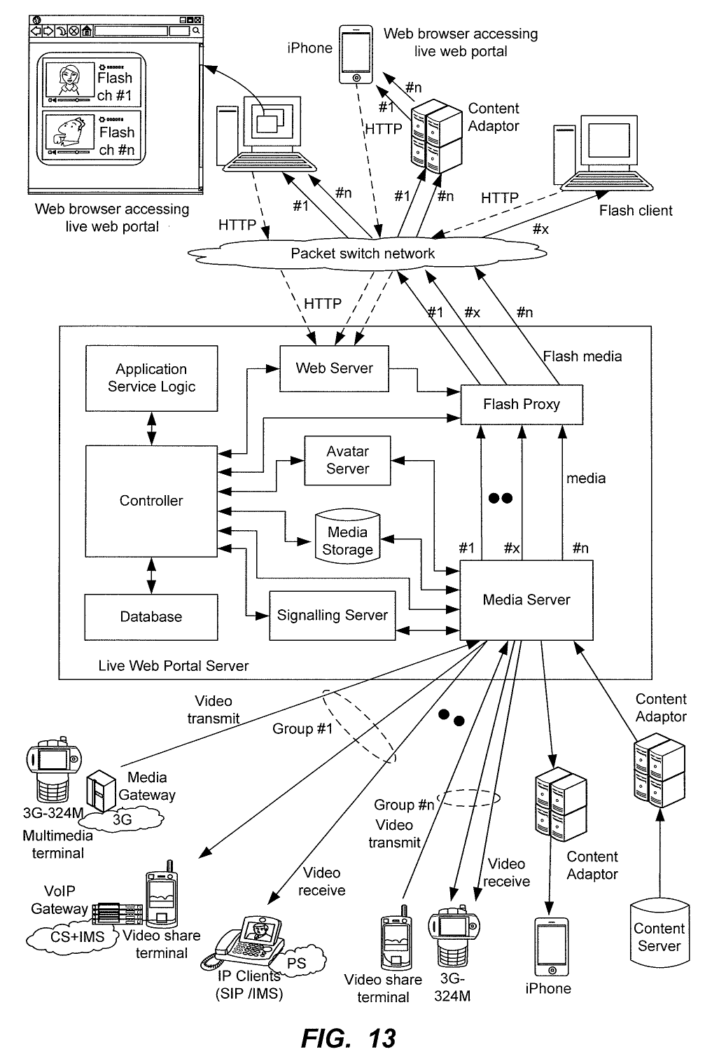

One preferred embodiment is depicted in FIG. 13. The live web portal application algorithm is the application service logic of the video value added service platform. All call sessions from 3G-324M devices/multimedia terminals, or from flash clients, or from IP clients, or from 3G devices including Apple iPhone and RIM BlackBerry devices calling/requesting into the video value added service platform are controlled and driven by the live web portal application algorithm at the application service logic. Sessions are provisioned by querying to a user subscription database. 3G-324M calls are established via a mobile switching center (MSC) and through a media gateway into the video value added service platform. Call signaling is handled at the signaling server and terminated at/driven by the application service logic via the controller. Media data are exchanged from the media server at the video value added service platform. For the live web portal hosting, it is operated at the web server such that any web browser can connect via one or more packet-switched networks. Video and audio contents to be shown at the live web portal use a flash plug-in per live web portal channel. User generated media from the 3G-324M device is delivered to the flash plug-in at the live web portal via the media server and through the flash proxy. The status of the user generated media contents per live web portal channel is monitored by means of the status update to and querying of the database. All media prompts and media contents are retrieved from the media storage. Alternatively, media contents can also be provided from a content server via a content adapter. A content adapter automatically performs media conversion to adapt to the environment of the delivery such as lowering the bitrate and changing the video format. Additionally, a content adapter is involved in a network resource restricted environment. A content adapter allows the video and audio contents to be re-adapted and shown on one or more plug-in windows using flash or QuickTime technology at the live web portal as an HTML page adapted into a mobile handset device such as an iPhone or a BlackBerry device. The server receiving the HTTP request from a mobile handset device detects the type of the device and adapts the media delivery to the live web portal on the device via the content adapter. A content adapter is described in U.S. patent application Ser. No. 12/029,119, filed Feb. 11, 2008 and entitled “METHOD AND APPARATUS FOR THE ADAPTATION OF MULTIMEDIA CONTENT IN TELECOMMUNICATIONS NETWORKS”, the disclosure of which is hereby incorporated by reference in its entirety for all purposes. Other additional components include an avatar server that allows streaming of dynamic avatar video that is synchronized to the voice of the caller with the floor for media content casting. Another alternative is to retrieve media content via an RTSP interface, possibly through an RTP proxy from an RTSP server.

FIG. 13 also shows an alternative embodiment according to the present invention. The embodiment has the callers using video share terminals to the mobile centrix using the CSI or Video Share network configuration such that video transmission and reception can be unidirectional only.

Enhanced Video Callback Service

An embodiment provides an enhanced video callback service on the ViVAS. In a conventional call session, if a caller attempts to reach a callee when the callee is not reachable, such as being busy or out of network signal coverage, either a busy tone is signaled back to the caller or the call is redirected to a mailbox or another designated number, or a call waiting tone will be played. When the callee cannot accept the call from the caller, the caller may try to re-attempt the call at a later time. On many occasions, the caller may forget to re-attempt the call. To alleviate this problem, an enhanced video callback service helps improve the situation by automatically calling out to the callee according to some preferences such as when the call re-attempt should occur, or when they are recognized to become available. In addition, to complement this service, multimedia as video value-added content can be provided to the caller during the waiting period.

The service can be offered to one or more video share enabled devices, 3G-324M video phones and other SIP devices or PC/Web based videophones, such as that enabled via a flash proxy for the communication.

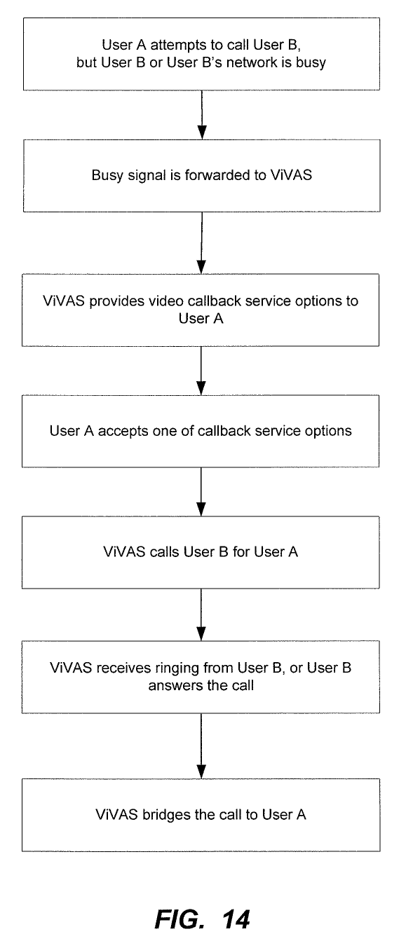

FIG. 14 is a flow chart depicting the method according to a preferred embodiment. When User A attempts to make a video call to User B and User B is unavailable due to either being busy or being temporarily out of wireless network coverage or not answering, etc, User A is offered a choice to wait and be connected to a Video Callback service by the ViVAS until User B is available. The call failure cases include if User B is available at a 2G network or User B is not provisioned to use 3G video service. If User A accepts an option provided by the video callback service, the ViVAS server keeps calling to User B for User A till User B is ready to answer the call. Once User B answers the call, the video callback service either bridges or transfers the call to User A. This procedure can be varied depending on service configuration provided by the option.

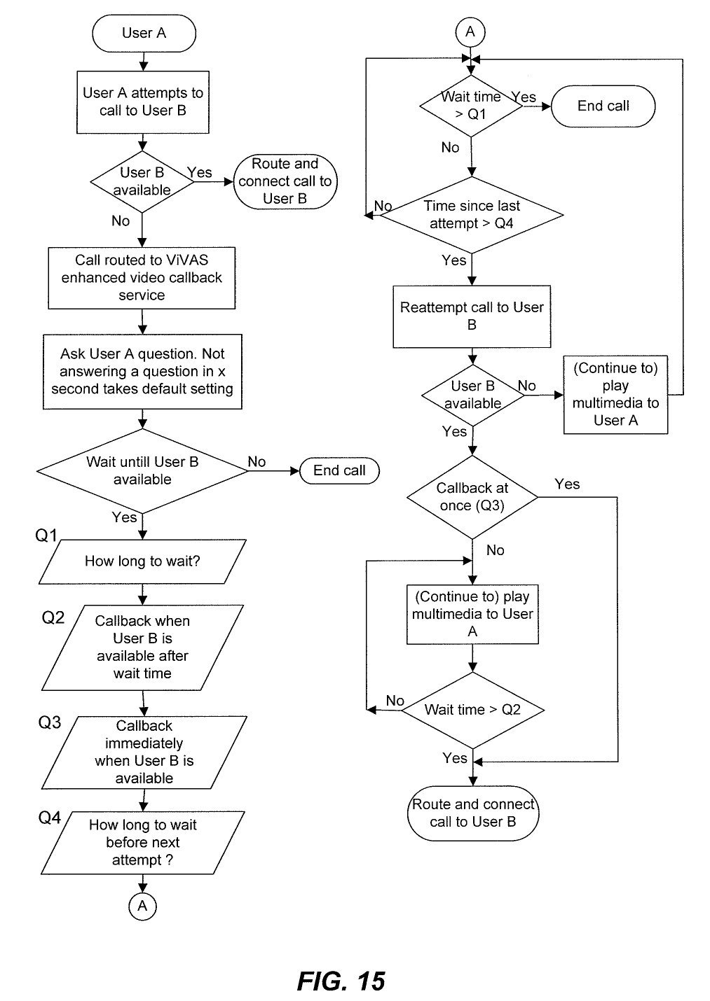

A detailed flow chart of an enhanced video callback service is further illustrated in FIG. 15. When User A attempts to make a video call to User B and User B is unavailable, User A is offered a choice to wait and remain connected to the service until User B is available. If User A accepts to wait, User A is offered more options. There may be a timeout on the selections of options where choices should be answered within a specific time, such as 10 seconds for each option. If an option is not responded to, the rest of the options can take default values without further waiting. If User A does not respond to the wait prompt, the logic will continue using the default settings or the pre-configured settings by User A. Without loss of generality, on User A accepting to wait, one possible set of questions is described here. A first question is generated by ViVAS to ask “How long to wait?” (e.g. 5 minutes). A second question is “Callback on callee being available when waiting time is over?” If this selection is made, when User A hangs up before timeout and the callback is selected, a callback will be made on User B becoming available. A third question is “Callback immediately as soon as callee is available?” If selected, and if User B does not answer the call, this question is inapplicable, so the answer becomes no. If the answer to the third question is no, the fourth question will be “How long to wait before next attempt?” (e.g. 1 hour, a minimum setting is possible such as 1 minute to meet operator or user satisfaction or regulatory requirements). After that, video value-added content is played. The video value-added content can be anything, being specific, or random. User A might even be further offered a selection of content they wish to see through one or more navigation menu driven by pressing DTMF keys or voice commands. Contents can be one-way or interactive. It can be continuous advertisements, movie clips, avatars, news, games, an online store, etc. They can be shown in random, each for specific duration such as 1 minute per category. Upon the waiting time being over, the User A is optionally prompted to extend the waiting time. If User A does not respond in specific time, say 10 seconds, the call can be ended. The maximum time duration that the system will attempt to determine User B's availability can be predefined, such as one day. The attempt is regarded as completed as long as there is a successful call between User A and User B. If during calling back to the User A on User B availability, User A becomes unreachable, the callback attempt can be made after a pre-configurable duration of time.

A further embodiment enables a service provider to impose different charging of the above service depending on the charging model. The enabling of the service can be a fixed rate on a monthly basis or additional premium charging can also be imposed depending on the user input of a specific set of questions to confirm if the user agrees to receive premium service during the enhanced video callback service. Premium charging can be a fixed price per usage incident or charged by minutes or similar. Examples of premium services are streaming of the latest news, interactive gaming, premium channels, showcases of the latest recommended movie trailers, etc.

A variation of the embodiment has the callers to the enhanced video callback service using the CSI or video share network configuration such that video transmission and reception can be unidirectional only.

A variation of the embodiment is the callers being able to initiate multiple video callback numbers at the same period of time using the enhanced video callback service. An example of the situation is at a video conference involving multiple parties such that one of the parties as a participant A who should be at the video conference is not available. The enhanced video callback service enables calling back to all other parties when the participant A becomes available to join the video conference.

Dynamic Advertisement

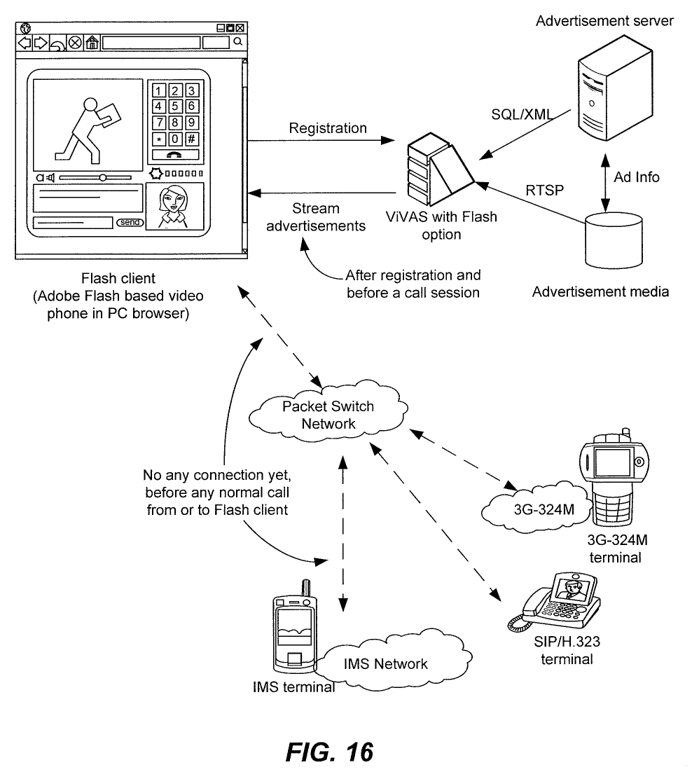

An embodiment provides an advertisement feature using the ViVAS platform that can be performed using flash. As illustrated in FIG. 16, flash advertisements are displayed to a user of a flash client in a web browser when a user logs on to the flash client, which subsequently routes through a flash proxy to register to a ViVAS platform. A flash client can be an Adobe (formerly Macromedia) Flash plug-in to a web browser. After a user logs on to a flash client and before attempting an outgoing call or receiving a call, the flash client is normally idle. To make better use of this idle time, multimedia advertisements or other entertainment (TV, latest clips from a UGC portal) can be streamed to the flash client. Thus it enhances the user enrichment of additional information and additionally increases the revenue of the service provider.

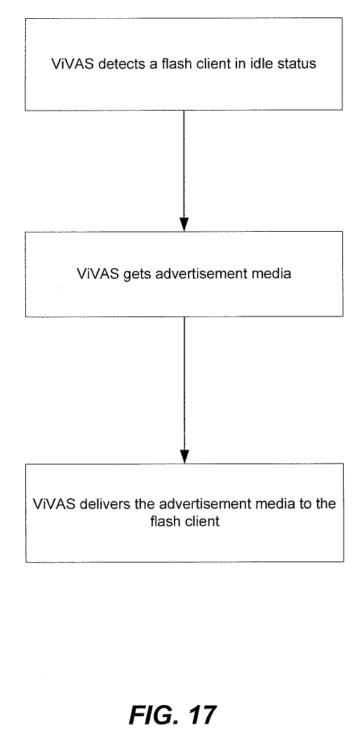

FIG. 17 is a flow chart depicting the method according to a preferred embodiment. The video value added service platform detects whether a flash client is in idle status. If the flash client is in idle status, the video value added service platform streams out multimedia advertisements from content servers to the flash client.

Another embodiment provides a dynamic advertisement feature similar to the flash advertisement using the ViVAS platform such that it is extended from a flash client to a multimedia client, such as a SIP client or a 3G-324M terminal via a gateway. Normally, after a multimedia client registers to a registration server, before making or accepting a call, the multimedia client stays idle. Dynamic advertisement makes use of this time to provide multimedia advertisements during the idle time in order to maximize the time usage. The registration server may be a SIP server. The dynamic advertisement in one embodiment is established in a session to the SIP client where it is modified to receive media independent of a call. For example the media is sent via a media SIP INVITE session that is automatically answered at the client for display.

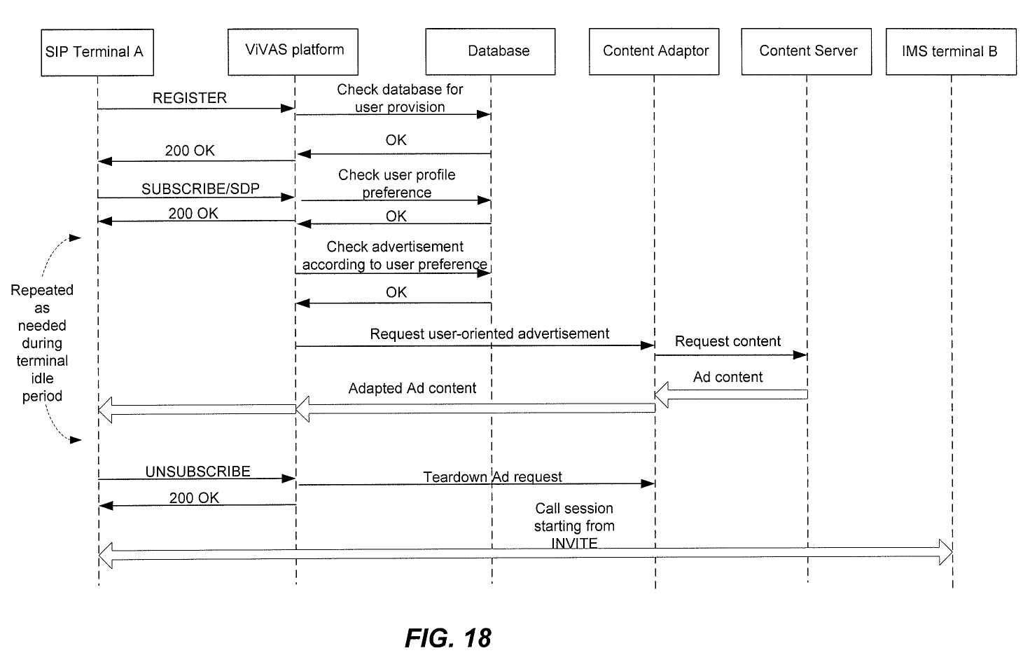

A call flow of a preferred embodiment is as illustrated in FIG. 18. A SIP multimedia terminal registers itself to the video value added service platform with a REGISTER signal. The video value added service platform checks a user database to confirm provisioning of value added service for dynamic advertisement. The confirmation response is sent back to the SIP terminal as an OK signal. The SIP terminal then sends a SUBSCRIBE signal with a set of service description parameters (SDP) to indicate its terminal capability. Then the video value added service platform checks the database for the user preferences, such as user habits, from the user profile and returns the result back to the video value added service platform through an OK signal. According to the user preferences, location of an advertisement is queried from a database as a dynamic advertisement source. The advertisement is determined at random under the group of advertisements matching the user preferences and the location of which is returned. The video value added service platform then requests the content of the advertisement from a content server via the content adapter using the returned location of the advertisement. The corresponding advertisement media contents, including one or both of video and audio, are streamed from the content server, which is adapted according to the network resource characteristics before passing to the video value added service platform via an RTP proxy back to the SIP terminal. On finishing playing an advertisement, the signaling is repeated from checking for another advertisement to stream another advertisement. The advertisement playing ends when a call session is to be started. An UNSUBSCRIBE signal is sent from the SIP terminal to the video value added service platform to indicate the end of advertisement playing. After the video value added service platform returns an OK, the SIP terminal starts a normal call session from an INVITE signal.

Video Share Customer Service

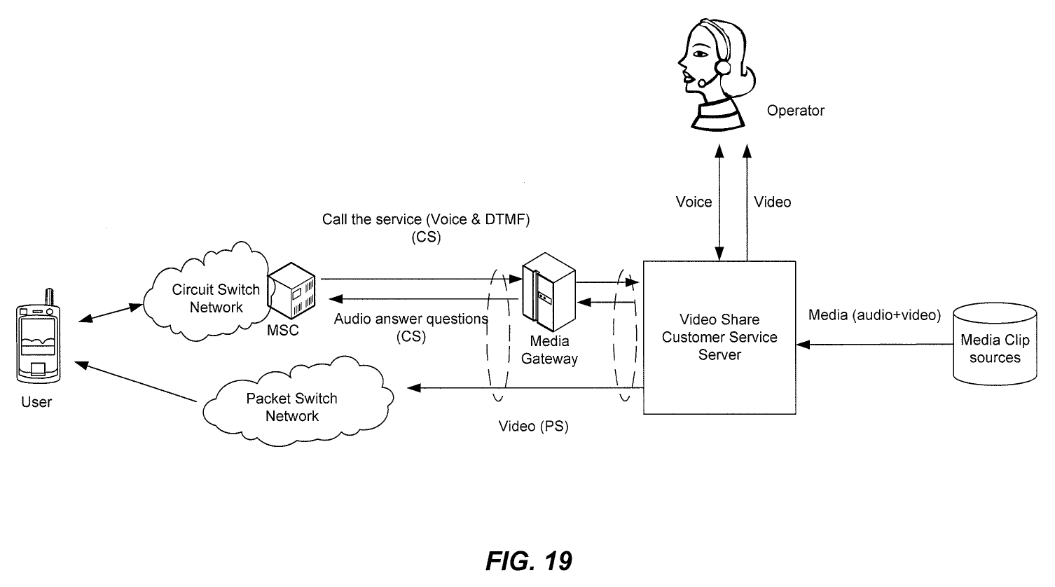

Augmenting a customer call center with video share should prove advantageous in resolving customer issues efficiently and with reduced attention/time from the call center agents. As illustrated in FIG. 19, a call is made to the customer service center and is answered by a call center application in the server. If the device of the caller is recognized to be both video share enabled and in video share coverage then session augmentation can begin and a range of additional options can become available into the service centre to dispatch the call and provide the best possible service. For example, additional video clips for helping the caller can be streamed to the caller through a video share channel while the audio is sent through circuit-switched networks.

Further, if the caller wants to speak to an operator, he can press some DTMF keys to connect to an operator. The operator can take the call and answer the caller's questions. Meanwhile, the operator's ability to service the call is enhanced as they have the ability to send recorded video clips to enhance the service.

A caller can send video or recorded video to an operator. The operator can watch and record the video sending from the caller to understand the caller's issues. For example, for the call center of a road assistance or emergency department, the operator can know the scene exactly through the video being sent from the caller if there is a traffic accident. The call center can provide quick assistance and action. The ability to receive clips at the service centre is also advantageous for the case of receiving product complaints or feedback or getting insurance claims verified and the like.

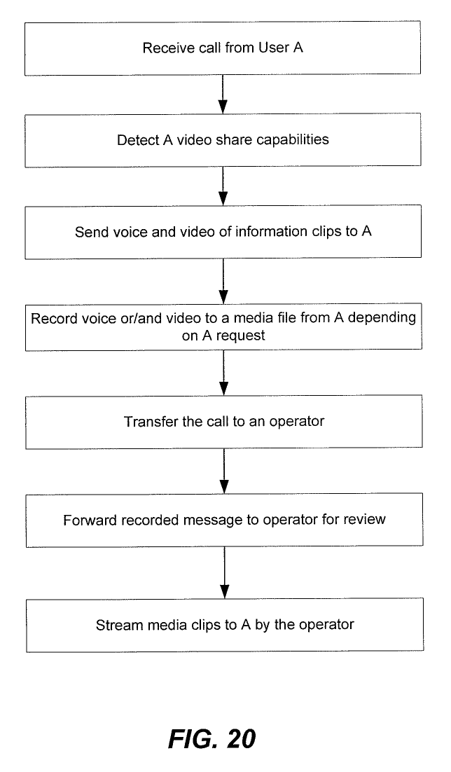

FIG. 20 is a flow chart depicting the method of video share customer service according to a preferred embodiment. The service platform receives a call from User A. The User A may call in without video share capabilities, such as the call is from a 2G network. The service platform detects the video share capabilities after receiving the call. If the User A has video share capabilities, the service platform streams video to User A or records video from User A to provide automatic customer services. The service platform can transfer the call to an operator if the User A needs further assistance. In addition, the service platform can forward and replay the recording video to the operator, or the operator can stream some media clips to the User A during voice chatting to enhance the customer service qualities and user experience.

A specific embodiment provides a video share customer service application on ViVAS. A caller calls into the service application using a video share enabled device, a 3G-324M video phone or another SIP device or a PC/Web based videophone, such as that enabled via a flash proxy for the communication. The application opens a video channel and starts playing a welcome message and then an instruction prompt. An instruction prompt asks the callee what the topic of the call is. The application checks if there is an available call agent or an operator from a database of agent availability for the customer service application.

An agent registers or has been pre-authorized to the customer service system for the agent access of the customer service system using a web interface or a software interface. He accesses the system by logging in with his account name and password. He registers himself to be available for receiving calls for the customer service, the status of which is updated to an agent availability database for the customer service application.

When the user starts the call to the customer service application, the application checks for agent availability from the database. If there is an agent available, the application makes a call to one of the available agents by either identifying the first available agent or selecting one of them, for example randomly, and then bridges the call with the caller. The user call record can be appended to a usage database which can also keep track of the current agent information to be bridged to. At the same time, the agent database is also updated to indicate the corresponding agent has become engaged. Video status prompts may be continuously updated to the caller on the progress of connection to an agent.

When no agent is available during the attempt to connect to an agent, the caller is offered value added media contents from the application server. Such contents include dynamic advertisements, dynamic avatar, and entertainment video such as movie trails.

Additionally, it is also understood that the examples and embodiments described herein are for illustrative purposes only and that various modifications or changes in light thereof will be suggested to persons skilled in the art and are to be included within the spirit and purview of this application and scope of the appended claims. For example, it is to be understood that the features of one or more embodiments of the invention may be combined with one or more features of other embodiments of the invention without departing from the scope of the invention.

What is claimed is:

1. A method of receiving media from a multimedia terminal, the method comprising:
establishing an audio link between the multimedia terminal and the server over an audio channel;
establishing a visual link from the multimedia terminal and the server over a video channel;
receiving, at the server, a first media stream from the multimedia terminal over the audio channel;
receiving, at the server, a second media stream from the multimedia terminal over the video channel; and
storing, at the server, the first media stream and the second media stream.

2. The method of claim 1 wherein the audio channel is a circuit switched voice channel and the video channel is a packet switched channel.

3. The method of claim 1 wherein storing comprises storing the first media stream and second media stream at the server into a multimedia file.

4. A method of transmitting media to a multimedia terminal, the method comprising:
establishing an audio link between the multimedia terminal and the server over an audio channel;
establishing a visual link from the multimedia terminal and the server over a video channel;
retrieving, at the server, a multimedia content comprising a first media content and a second media content;
transmitting, from the server, a first media stream associated with the first media content to the multimedia terminal over the audio channel; and
transmitting, at the server, a second media stream associated with the second media content to the multimedia terminal over the video channel.

5. The method of claim 4 wherein the audio channel is a circuit switched voice channel and the video channel is a packet switched channel.

6. The method of claim 4 wherein the multimedia content is a multimedia file.

7. A method for providing a multimedia service to a multimedia terminal, the method comprising:
establishing an audio link between the multimedia terminal and a server over an audio channel;
detecting one or more media capabilities of the multimedia terminal;
providing an application logic for the multimedia service;
establishing a visual link between the multimedia terminal and the server over a video channel;
providing an audio stream for the multimedia service over the audio link;
providing a visual stream for the multimedia service over the video link;
combining the video link and the audio link; and
adjusting a transmission time of one or more packets in the visual stream to synchronize the visual stream with the audio stream.

8. The method of claim 7 wherein the audio channel is established on a circuit switched network and the video channel is established on a packet switched network.

9. The method of claim 7 wherein the multimedia service is an interactive video and voice response service.

10. The method of claim 7 wherein detecting one or more media capabilities of the multimedia terminal comprises:
receiving an identification associated with the multimedia terminal from a voice call signaling message;
determining one or more privileges of the multimedia terminal;
detecting one or more video capabilities provided by a network associated with the multimedia terminal; and
determining the multimedia terminal comprises one or more characteristics for the multimedia service.

11. The method of claim 7 wherein establishing a visual link comprises:
originating a video session to the multimedia terminal via a packet-switched network;
sending one or more voice messages to the multimedia terminal wherein the one or more voice messages are provided to assist a user in establishing a second video session;
receiving a connection message from the multimedia terminal for the second video session; and
negotiating one or more video capabilities for the second video session with the multimedia terminal.

12. The method of claim 7 wherein combining the visual link and the voice link comprises:
registering a first call ID associated with the voice link to a database;
registering a second call ID associated with the visual link to the database; and
linking the first call ID and the second call ID as a single media call session.

13. The method of claim 7 wherein adjusting a transmission time of sending one or more packets comprises:
estimating an end-to-end delay of the audio link;
estimating an end-to-end delay of the video link; and
controlling a sending time of the one or more packets depending on a difference between the end-to-end delay of the audio link and the end-to-end delay of the video link.

14. The method of claim 7 wherein adjusting a transmission time of one or more packets comprises:
receiving, at the server, a message comprising network delay data; and
determining the transmission time of one or more packets from the message.

15. The method of claim 7 wherein delivering a multimedia service further comprises:
executing the application logic;
loading a media content from a content provider system;
sending an audio part of the media content to the multimedia terminal over the audio stream;
sending a video part of the media content to the multimedia terminal over the video stream;
receiving an incoming audio stream from the voice link; and
receiving an incoming video stream from the video link.

16. The method of claim 7 wherein the multimedia service is a video share blogging service, wherein the video share blogging service further comprises:
establishing a media session between the multimedia terminal and the server, wherein the media session comprises of a two-way circuit-switched voice call, and a one-way packet-switched video stream from the server to the multimedia terminal;
sending a first voice prompt message and an associated video message to the multimedia terminal;
closing the one-way packet-switched video stream;
playing a second voice prompt message to the multimedia terminal, the second voice prompt being associated with a request for the multimedia terminal to begin a video session;
accepting a second one-way packet-switched video stream from the multimedia terminal to the server;
combining a voice signal from the two-way circuit-switched voice call and a video signal from the second one-way packet-switched video streaming into a recorded media file.

17. The method of claim 7 wherein the multimedia service is a video share casting service, wherein the video share casting service further comprises:
establishing a first voice call from a first terminal associated with a first participant to the server;
establishing a first one-way video channel from the server to the first terminal;
determining the first participant has a priority status;
establishing a second one-way video channel from the first terminal to the server;
receiving a second video stream from the second one-way video channel, and transmitting the second video stream on a broadcasting channel.

18. A method for providing a multimedia portal service from a server to a renderer, the renderer being capable of receiving one or more downloadable modules, the method comprising:
receiving at the server, a request associated with the renderer;
providing, from the server to the renderer, a first module comprising computer code for providing a first media window supporting display of streaming video;
providing, from the server to the renderer, a second module comprising computer code for providing a second media window supporting display of streaming video;
transmitting, from the server to the renderer, a first video session for display in the first media window; and
transmitting, from the server to the renderer, a second video session for display in the second media window.

19. The method of claim 18 wherein the renderer is a web browser.

20. The method of claim 18 wherein the first module is a Flash file.

21. The service of claim 18 further comprising:
transmitting, from the server to the renderer, a first audio session associated with the first video session.

22. The method of claim 21 wherein the first audio session is on a circuit switched network and the first video session is on a packet switched network.

23. The method of claim 18 wherein the first media window is provided by a plug-in technology.

24. The method of claim 18 wherein transmitting the second video session is triggered by a second action.
